(19) United States
(12) Patent Application Publication
(10) Pub. No.: US 2005/0038614 A1
(43) Pub. Date: Feb. 17, 2005

(54) Remote battery monitoring systems and sensors

(76) Inventors: Steve Botts, Ramona, CA (US); Jeff Bevis, Oceanside, CA (US)

Correspondence Address: Catalyst Law Group, Suite 220, 4330 La Jolla Village Drive, San Diego, CA, 92122, US

(21) Appl. No.: 10/495,842

(22) PCT Filed: Nov. 27, 2002
(86) PCT No.: PCT/US02/37888

Related U.S. Application Data
(60) Provisional application No. 60/333,728, filed on Nov. 27, 2001.

(51) Int. Cl. G06F 19/00

(52) U.S. Cl. 702/63

(57) ABSTRACT

A remote battery monitoring system and sensors are disclosed in which a plurality of telesensors are connected to batteries in a battery string. The telesensor measure battery data such as voltage, current, and temperature and wirelessly transmit the battery data to a control and collection unit. The control and collection unit receives, processes, analyzes, and stores the battery data. Remote monitoring software running on the control and collection unit can be configured to provide warning alarms when the battery data is outside present limits.

1. CROSS REFERENCE TO RELATED APPLICATION This application is a continuation-in-part of co-pending provisional application Ser. No. 60/333,728, entitled “Wireless Battery Monitoring System and Sensor” by Tietsworth et al., owned by the assignee of this application and incorporated herein by reference.

### BACKGROUND OF THE INVENTION

1. Field of the Invention

The present invention is directed to systems and sensors for monitoring batteries. More particularly, the present invention is directed to wireless battery monitoring systems and sensors which can remotely monitor the health and status of strings of batteries.

2. Background Information

Traditional maintenance of battery strings has focused on a series of routines mandating periodic measurement of battery parameters, such as cell voltage and specific gravity. It was thought that if batteries were physically maintained with proper water levels, visual inspections, and correct voltage and specific gravity readings, the batteries would provide the necessary capacity when needed. However, when forced online, batteries often failed or produced far less than stated capacity even if they were properly maintained. It is now well-settled that these types of measurements are not accurate predictors of battery capacity.

Battery monitoring systems have been proposed for monitoring the capacity of an entire string of batteries without manual intervention. Such systems typically comprise hard wiring the individual batteries in a battery string to a battery test unit. The wire harness includes a dedicated electrical connection to each battery terminal. Therefore, for a typical 24 cell string of batteries, the harness will include at least 48 wires. The battery test unit employs a group of relays that are controlled by a controller. The group of relays typically consists of 48 relays, one for each battery terminal in the string of batteries. The controller switches separate relays in the relay group to connect an individual battery to a battery tester, which typically comprises a multi-meter. The multi-meter provides a reading corresponding to the status of the currently connected battery.

This system has several shortcomings. First, battery strings are typically housed in tightly confined rooms, thus it can be difficult and expensive to install and maintain the wire harness, wires and relays. Sometimes lack of space at the battery string location can preclude using a wired system because there is no room available for the wires, wire harness and relays.

Another shortcoming is that the system can only indicate the status of one battery at a time. The system is not configured to collect or process the data, to store historical data or to provide real time alerts indicating potential problems with individual batteries.

Thus, it is desirable to provide a battery monitoring system that is space efficient and can provide data processing, data collection and storage, the ability to view the status of more than one battery at a time, remote alert capability, as well as other remote monitoring services.

### SUMMARY OF THE INVENTION

These needs and others are satisfied by a remote battery monitoring system and sensor according to the present invention which comprises a plurality of wireless telesensors connected to batteries in a battery string, a HUB for receiving and collecting data measured by the plurality of telesensors, and a monitoring unit for storing, analyzing, and displaying the data measured by the telesensors and collected by the HUB.

### BRIEF DESCRIPTION OF THE DRAWINGS

FIG. 1 is a block diagram of one embodiment of a remote battery monitoring system according to the present invention;

FIG. 2 is a block diagram of one embodiment of the data acquisition component shown in FIG. 1;

FIG. 3 is a detailed top view of the data acquisition component of FIG. 2;

FIG. 4 is a block diagram of an alternative embodiment of the data acquisition component shown in FIG. 1;

FIG. 5 is a detailed top view of the data acquisition component of FIG. 4;

FIG. 6a is a block diagram of one embodiment of the collection component of FIG. 1;

FIG. 6b is a block diagram of an alternative embodiment of the collection component of FIG. 1;

FIG. 7 is a graphical illustration of a representative battery voltage/current curve;

FIG. 8 is a graphical illustration of a representative battery discharge curve;

FIG. 9 is a graphical illustration of a plotting of a normal battery discharge curve verses a defective battery discharge curve;

FIG. 10 is a block diagram of the voltage telesensor of FIG. 1;

FIG. 11 is an electrical schematic diagram of one embodiment of temperature measuring circuit according to the present invention;

FIG. 12 is a block diagram of the current telesensor of FIG. 1;

FIG. 13 is a cross-sectional view of one embodiment of the current transducer of FIG. 12;

FIG. 14 is an electrical schematic diagram of one embodiment of the analog interface circuit of FIGS. 10 and 12;

FIG. 15 is an electrical schematic diagram of one embodiment of a sign indication circuit according to the present invention;

FIG. 16 is a block diagram of the shunt sensor of FIG. 3;

FIG. 17 is a flow chart of one embodiment of the firmware initialization process;

FIG. 18 is a flow chart of one embodiment of slave telesensor operation;

FIG. 19 is a flow chart of one embodiment of master telesenor operation.

### DETAILED DESCRIPTION OF A PREFERRED EMBODIMENT OF THE INVENTION

In accordance with the present invention, a remote battery monitoring system and sensor is described that provides distinct advantages when compared to those of the prior art. The invention can best be understood with reference to the accompanying drawing figures.

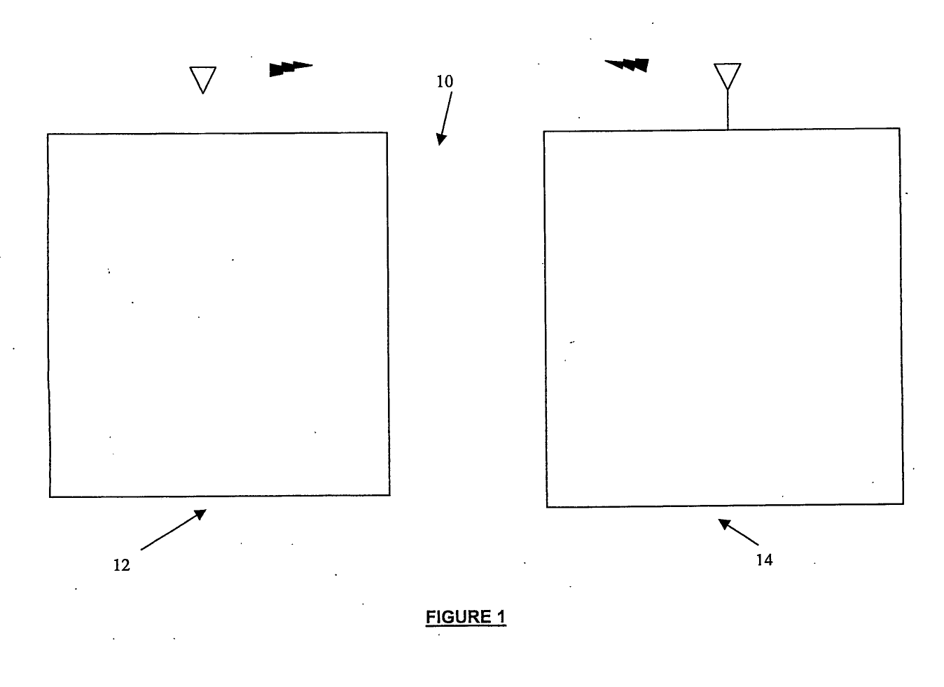

Referring now to the drawings, a remote battery monitoring system according to the present invention is generally designated by reference numeral 10 in FIG. 1. The system 10 comprises a data acquisition component 12 and a control and collection component 14. The system 10 is configured for remotely monitoring the health and status of batteries in a series string such as found in high reliability Uninterruptible Power Systems (UPS) Backup Systems, Standby systems and Telecommunications Systems (TELCO) DC power applications. The data acquisition component 12 is attached to each battery in a string and measures raw data including voltage, temperature and current. The data acquisition component 12 wirelessly transmits the data to the control and collection component 14.

In general, a system 10 according to the present invention can be configured to monitor a string of series connected lead acid batteries. The batteries are typically supplied with a float current intended to keep the voltages of the batteries at certain levels between uses to compensate for self-discharge of the battery cells. The batteries are normally 2V, 6V, 12V, and/or 24V and are connected in multiples of 10 cells, (i.e. 10, 20 . . . 80) to provide typical voltages (i.e. 120V, 240V, 480V, etc.). Multiple batteries strings can be connected in parallel to provide the required power output. A system 10 according to the present invention is well suited to many power applications because the wireless nature of the system 10 does not require attaching each battery to a central device with an infrastructure of cables that must be maintained.

The control and collection component 14 collects, stores, analyzes, processes, organizes, and distributes the data received from the data acquisition component 12. The control and collection component 14 can be configured to make judgments and predictions regarding battery health and capacity and to trigger alarms when various parameters are outside of expected operating limits. The control and collection component 14 also controls operation of the data acquisition component 12.

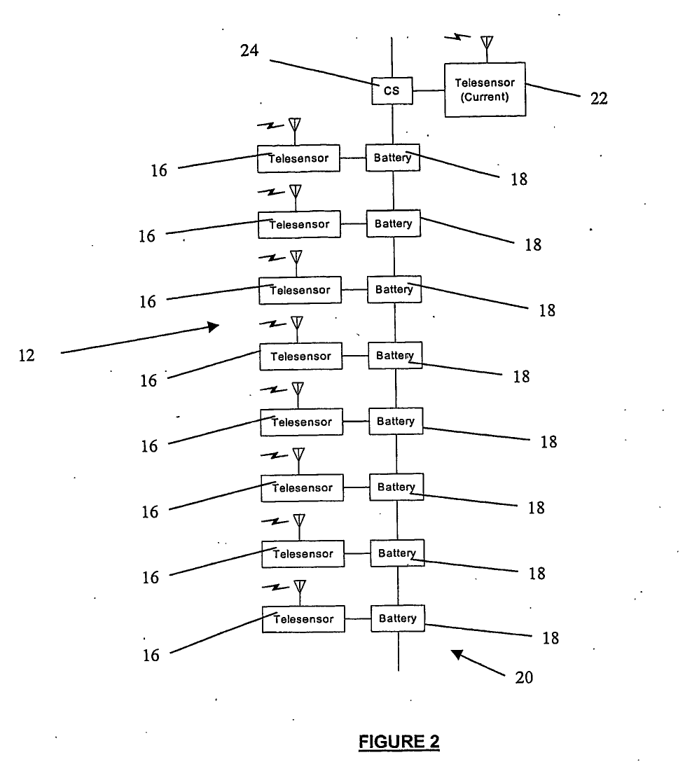

FIG. 2 illustrates one embodiment of a data acquisition component 12 according to the present invention. The data acquisition component 12 comprises an array of wireless telesensors 16, 22. In this embodiment, individual voltage telesensors 16 are attached to each battery 18 in the battery string 20 to be monitored. A current telesensor 22 is also attached to the system through a hall-effect current measuring transducer 24. Each individual voltage telesensor 16 can be configured to measure various parameters such as, among other things, battery voltage and battery case temperature of the battery to which it is attached as well as cabinet ambient temperature. The current telesensor 22 and current measuring transducer 24 can be configured to measure the charge and discharge current in the battery string 20. These parameters are wirelessly sent to the control and collection component 14 of the system 10.

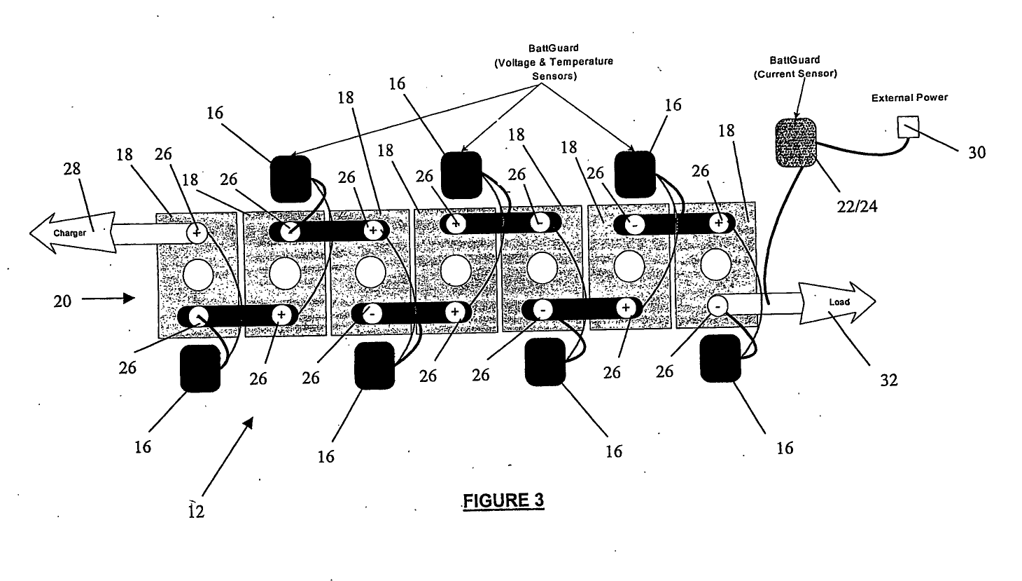

FIG. 3 illustrates the installation details of the data acquisition component 12 shown in FIG. 2. Each voltage telesensor 16 is connected across the leads 26 of a battery 18. The attachment can be made using a contact adhesive to form a semi-permanent accessory. In the embodiment shown in FIG. 3, a voltage telesensor 16 is connected to each battery 18 in the battery string 20. However, voltage telesensors 16 can be connected across several batteries or even an entire battery string 20. Other configurations of sensors and inputs can be made to tailor to the particular needs and requirements of the system to be monitored.

Since these types of battery strings 20 are typically float charged; each voltage telesensor 16 can be parasitically powered from the battery 18 it is monitoring. In order to minimize the impact on the battery string 20, the voltage telesensors 16 are configured to use low power and low duty cycle techniques so that the power used by the voltage telesensors 16 is less than the power returned by the charging system 28. The current telesensor 22 and current measuring transducer 24 are connected at the load end 32 of the battery string 20. The current telesensor 22 and current measuring transducer 24 are powered by an external power source 30.

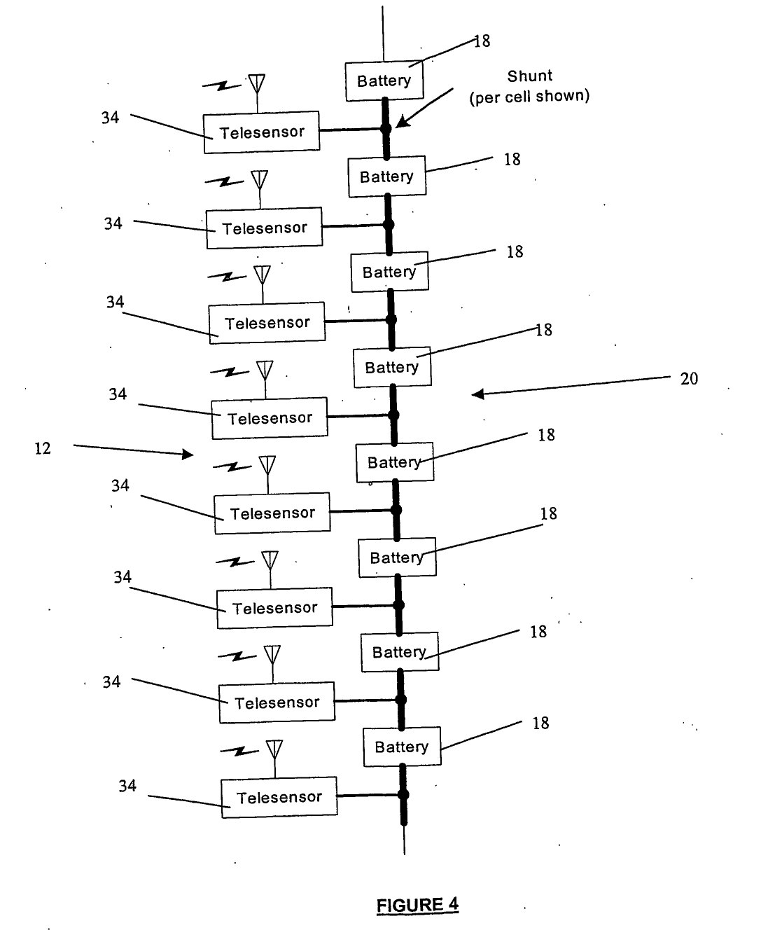

An alternative embodiment of the data acquisition component 12 of the system 10 is shown in FIG. 4. This embodiment features an array of shunt telesensors 34 with one shunt telesensor 34 for each battery 18 in the battery string 20. The shunt telesensors 34 use a low-cost alloy based shunt to measure current as well as the voltage and temperature measurements made by the voltage telesensors 16 of FIGS. 2 and 3. The shunt telesensor 34 also provides low thermal resistance path to the battery core. Thus, battery core temperature measurements can be made by the shunt telesensors 34 outside of the battery case, which may help early detection of thermal faults.

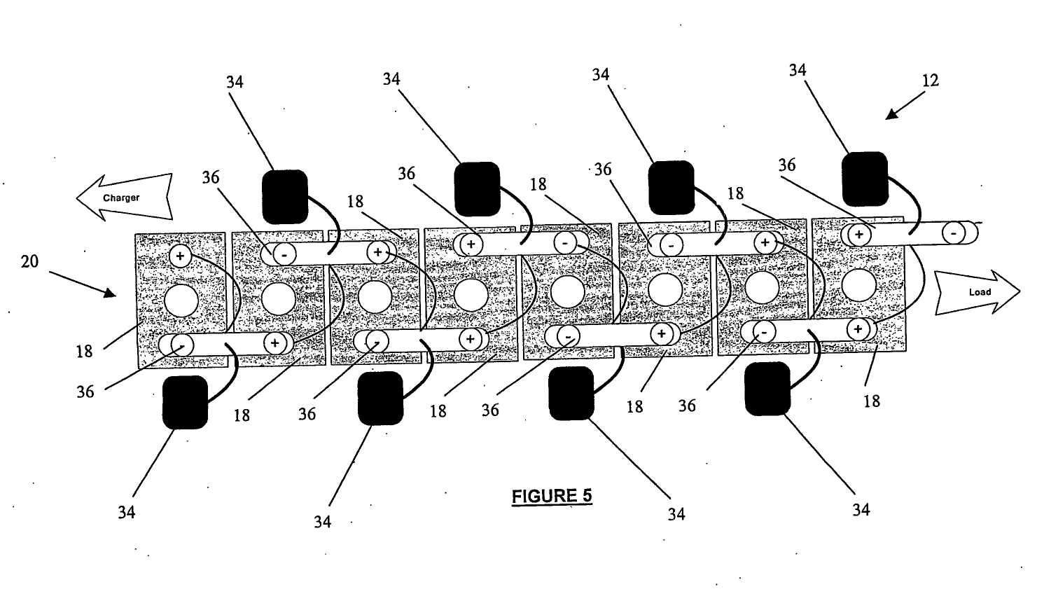

FIG. 5 shows the installation details of the shunt telesensors 34 into a battery string 20. Each shunt telesensor 34 is connected to an inter-battery tie 36. Alternatively, the shunt telesensors 34 can be connected between batteries 18 replacing the inter-battery ties 36. This connection can also be made with a contact adhesive. The shunt telesensors 34 can be parasitically powered from batteries 18. In the embodiment shown in FIG. 5, a shunt telesensor 34 is connected to each battery 18 in the battery string 20. However, shunt telesensors 34 can be connected across several batteries 18 or even an entire battery string 20. Other configurations of sensors and inputs can be made to tailor to the particular needs and requirements of the system to be monitored.

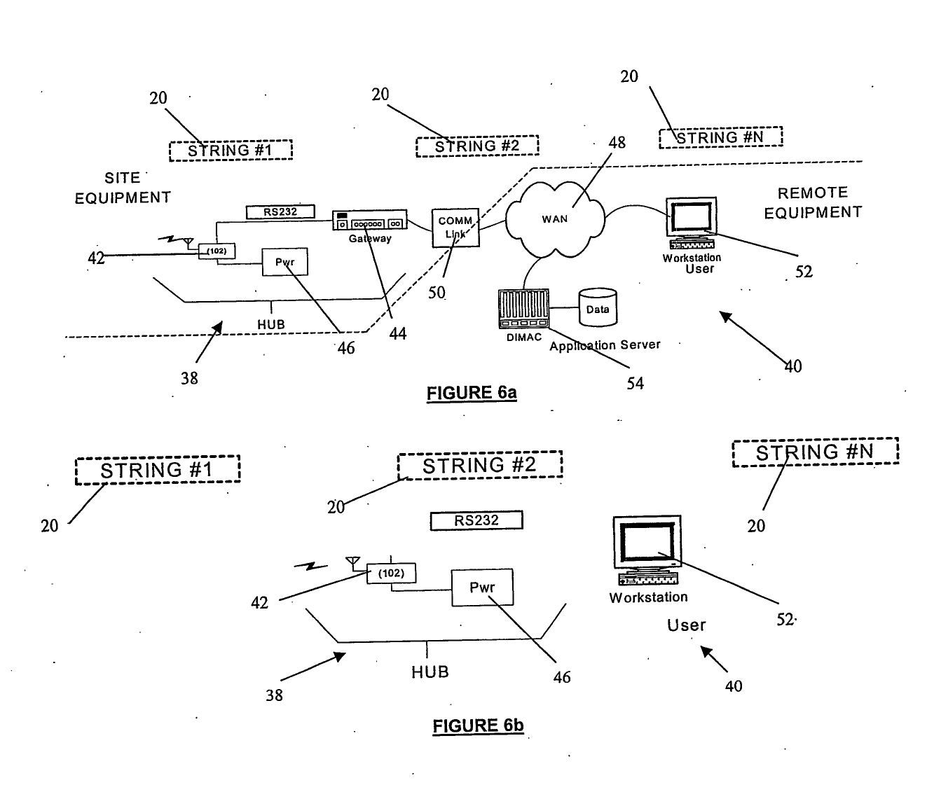

One embodiment of a control and collection component 14 of system 10 is shown in FIG. 6a. The control and collection component 14 includes a HUB 38 connected to a monitoring unit 40. In this configuration, the HUB 38 is typically located locally at the battery site while the monitoring unit 40 is remotely located.

The HUB 38 communicates wirelessly with telesensors connected to various battery strings 20. The HUB 38 collects data (such as the measured voltage, current and temperature information) from the telesensors and forwards it to the monitoring unit 40 for processing and storage. As shown in FIGS. 6a and 6b, a single HUB 38 can be configured to monitor and control several battery strings 20 even if the battery strings 20 are in different locations, as long as a radio link can be established between the telesensors connected to the battery string 20 and the HUB 38.

In this embodiment, the HUB 38 comprises master unit telesensor 42 connected through an RS 232 serial connection to a gateway 44. The master unit telesensor 42 is powered by an external power supply 46. The gateway 44 connects to a wide area network (WAN) 48 through a communication link 50. The monitoring unit 40 connects to the HUB 38 through the WAN 48.

In this embodiment, the monitoring unit 40 includes a user workstation 52 and an application server 54. The monitoring unit 40 also includes remote monitoring software that is configured to analyze the data received from the individual telesensors. In this embodiment, the remote monitoring software is run on the application server 54, which is also configured to store the data received from the telesensors. This data and analysis can be accessed through the WAN 48 by users at remote workstations 52. Thus, in this embodiment, the user workstation 52 does not require proprietary software but can, instead, gain access to battery string information using a standard network browser such as Microsoft™ Internet Explorer or Netscape® Communicator.

FIG. 6b illustrates an alternative embodiment of the control and collection component 14. This configuration is typically used with the HUB 38 is located remotely from the battery strings 20. In this embodiment, the HUB 38 comprises a master unit telesensor 42 connected directly to the monitoring unit 40 via an RS 232 serial communication line. The master unit telesensor 42 communicates with the telesensors connected to the battery strings 20 and is powered by an external power source 46.

In this embodiment, the monitoring unit 40 comprises a user workstation 52 running the remote monitoring software. This configuration eliminates the need for an application server because the user workstation 52 is configured to perform the operations of the application server of FIG. 6a.

The wireless connection between the telesensors 16, 22, 34 and the master unit 42 can operate an a standard wireless protocol, such as Bluetooth, IEEE 802.11, etc. or on a proprietary standard, such as the one discussed herein. Preferably, the telesensors 16, 22, 34 are low power, 2.4 GHz Direct Sequence Spread Spectrum (DSSS) telemetry transceivers intended for monitoring industrial battery systems. The telesensors 16, 22, 34 can be designed to be low cost devices which remain attached to a battery 18 throughout its life. Intended operating frequencies are in the unlicensed Industrial Scientific and Medical (ISM) band. Each telesensor 16, 22, 34 includes a highly integrated Radio Frequency Application Specific Integrated Circuit (RF/ASIC) radio transceiver and a mixed signal System on a Chip (SOC) processor/microcontroller. Specialized telesensors 16, 22, 34 are configured to attach to various components of a battery system.

The remote monitoring software can be configured to trigger warning alarms when various parameters fall outside the expected operating limits of the monitored battery strings 20. The remote monitoring software also can be configured to make judgments and predictions regarding the individual batteries' 18 or battery strings' 20 health and capacity. Because data from the telesensors is aggregated, the remote monitoring software can also perform long term analysis on stored and/or historical data.

The remote monitoring software is capable of allowing the various alarm and/or warning set points to be set by the end user. The alarms and/or warnings can be set to trigger when a value either exceeds or falls below the set point. An alarm and/or warning can be signaled in any number of ways including displaying a visual alarm/warning signal including a fixed message, color scheme (typically a red for alarm and yellow for warning), or electronic notification such as an e-mail or pager notification. The alarm and warning events can be logged in files, such as an ASCII text files for historical purposes and future retrieval.

The system 10 should be configured to provide the user with sufficient information to aid in determining battery health. Depending on the desired application, this can be as simple as receiving and storing raw data for periodic maintenance and/or warranty claims or as complex as providing analysis and trending information for predictive maintenance of batteries 18. The information can be provided in various forms such as numerical data, bar graphs, charts, or other appropriate indicators. A quick go/no go indication can be set up through color schemes such as green for go, amber for warning or suspect, and red for fault or out of tolerance condition. The system 10 should also be capable of providing sufficient data capabilities for secondary analysis of battery health such as battery impedances, etc.

This data can be gathered on an opportunistic basis without active testing or disturbing the battery string 20. In some cases, where necessary, control signals can be sent to the telesensors requesting that data measurements be made. The telesensors can also be configured to send status information related to the telesensors (as opposed to the battery string). In this manner, the control and collection component 14 can be used for remotely controlling operation of the telesensors.

Since impedances are important indicators of battery health, but are only valid for certain conditions, an expert or expert system may be useful to interpret these results. Charging current can be monitored for overcharge conditions verse temperature. Rapid charge (values on the order of C/10 for several minutes) can be monitored as well as temperatures looking for thermal runaway conditions. All of these conditions can be made as an alarm notification or warning condition.

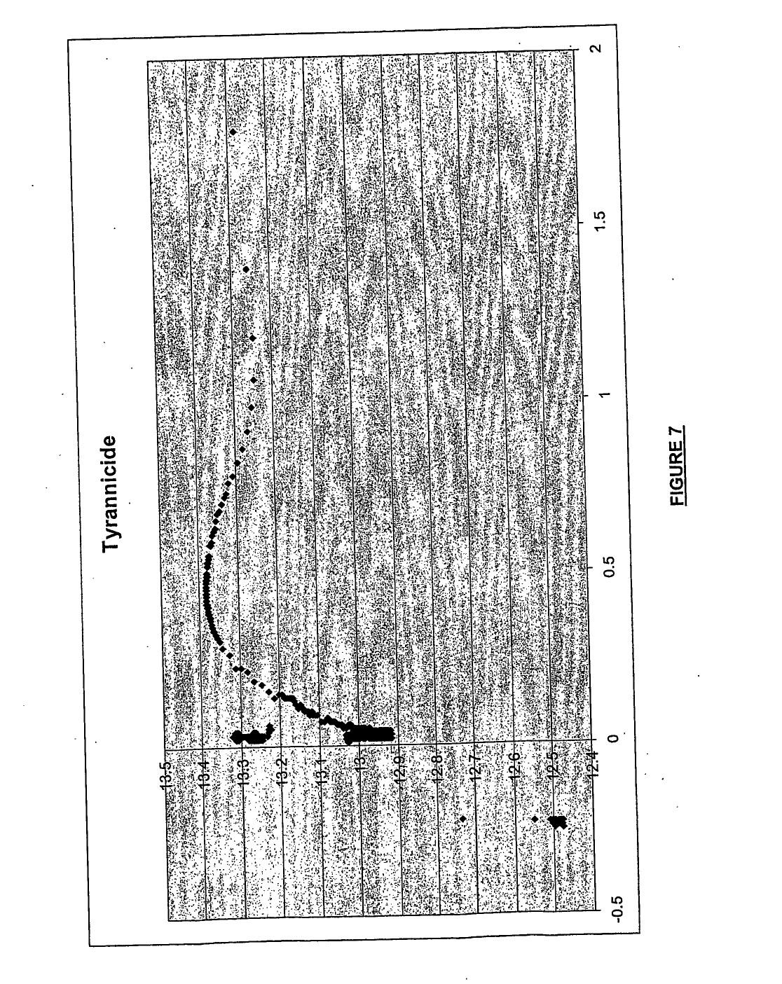

Effective internal impedance is dependent on temperature, state of charge, and load. The effective impedance is lower for a fully charged battery. A representative V/I battery curve is shown in FIG. 7. It can be important for a battery system to have low internal or low inter-cell impedances when the battery system must support a high current discharge. Low temperature, use, and long storage all increase a battery's impedance. In applications where batteries are continuously trickle charged at rates such as 0.01 C to 0.1 C, the impedances are low enough to make an excellent ripple filter. But if the AC ripple current and voltage can be measured, the impedances can be calculated by using simple Ohm's law calculations. Rules of thumb such as a 5× increase in the internal resistance for battery replacement require record keeping, as well as comparing the results to other batteries in the system. Quick discharge events on the order of 1 C to 10 C for sufficient times are ideal for calculating the resistance. These resistances can be calculated by continuously monitoring the batteries and opportunistically searching for sufficient changes in current to solve the following known equations:
Rₑ(Ω)=ΔV/ΔI=(V_{L}−V_{H})/(I_{L}−I_{H})
Where: V_{H}, I_{H}=Voltage and Current prior to event
V_{L}, I_{L}=Voltage and Current after the event

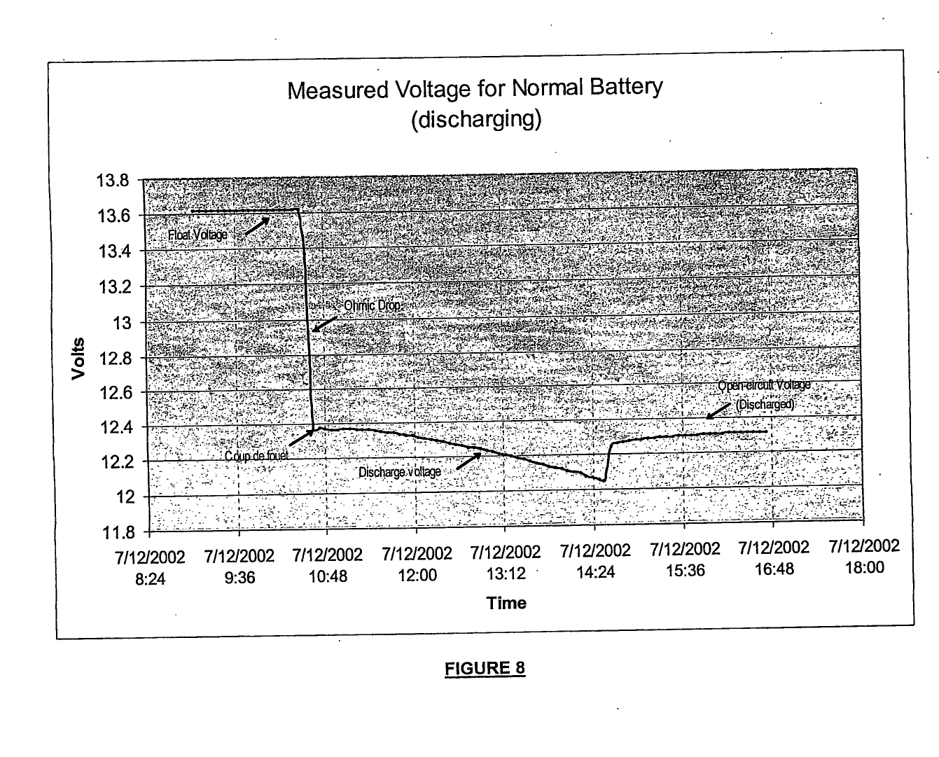

During a discharge event the system 10 shall provide storage and plots to allow analysis of discharge curves. Events, such as the “float voltage”, “ohmic drop”, “coup de fouet”, “battery discharge voltage”, “Final voltage” and “Discharge Open circuit voltage” can be determined. Further, these parameters may be analyzed by software and provide a non-expert user a battery health indication. One typical battery discharge curve is shown in FIG. 8.

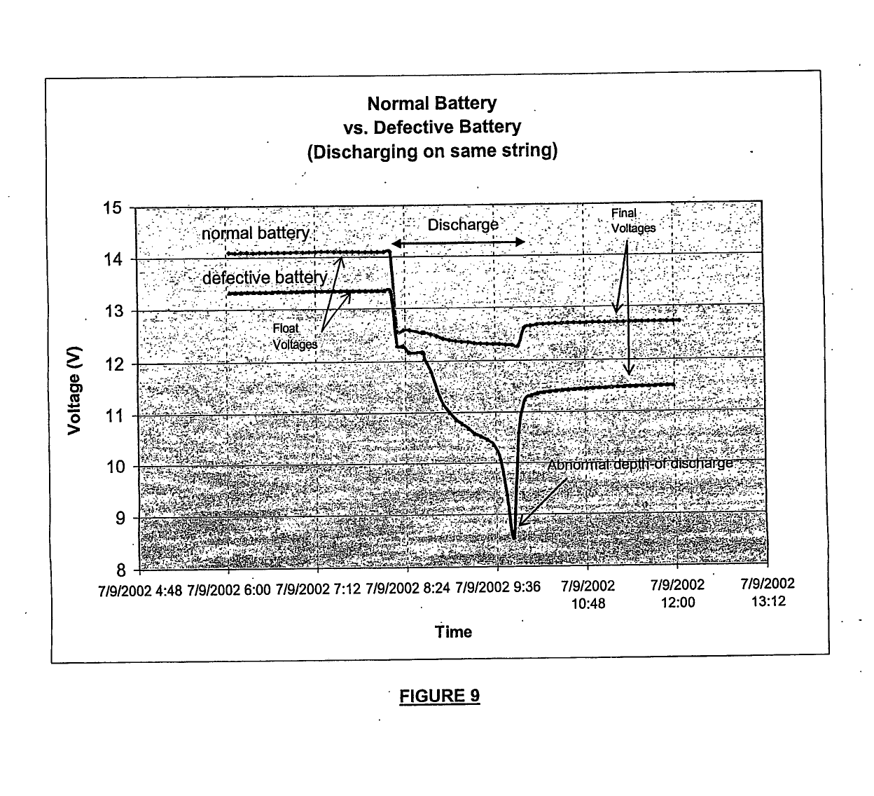

Life cycles and rates of discharge effects on battery capacity can be monitored on a historical basis. Discharge cycles can be counted and monitored. Heavy discharges decrease the total available capacity of the batteries 18. Manufacturers typically specify the number of discharges related to numbers of cycles warranted at various discharge rates and temperatures. All discharges can be monitored and historically archived for analysis against the battery manufacturer recommendations. Various problems are sometimes evident only during a discharge event. The system 10 can collect and compare data to expected values in a graphical format as shown in FIG. 9 to help prevent failures.

The telesensors 16, 22, 34 can be configured to store parameters in flash memory. Some SOC processors 58 come standard with flash memory. For example the micro controller can include 28K of main flash memory and a 128B separate memory region. This separate 128B memory region can be used to store configuration parameters. This data can be stored along with a CRC check code to validate the data upon retrieval.

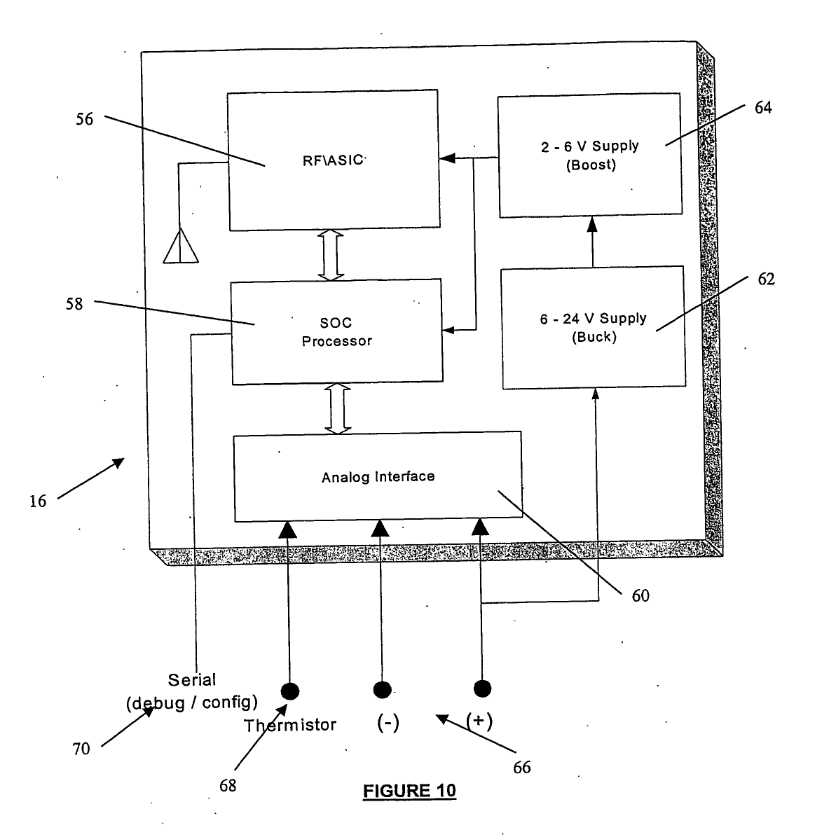

FIG. 10 shows a block diagram illustrating one embodiment of a voltage telesensor 16 according to the present invention. Voltage telesensor 16 comprises an RF/ASIC 56, an SOC processor 58, an analog interface circuit 60, a 6V-24V supply 62, and a 2V-6V supply 64. The analog interface circuit 60 receives the inputs 66 from the battery 18 as well as a thermistor input 68 and converts analog signals received on the inputs into digital signals which are sent to the SOC processor 58.

The SOC processor 58 provides the control and measurement capabilities of the voltage telesensor 16. The SOC processor 58 receives the digital signals from the analog interface circuit 60, processes the data encoded in the digital signals and routes data to the RF/ASIC 56 which wirelessly transmits the processed data to the HUB 38 of the control and collection component 14. The SOC processor 58 also includes a serial debug/configuration input 70 which can be used for setting up or maintaining the voltage telesensor 16. The SOC processor 58 can derive the time base from the RF/ASIC 56 or from a separate crystal connected to the SOC processor 58.

The SOC processor 58 can contain a 12-bit A/D converter. A 2.5V reference voltage can be supplied to this converter. A 4-bit programmable-gain amplifier (PGA) can also be included in the SOC processor 58 and can be used in concert with the A/D converter to achieve sampling with 16-bit dynamic range, though only 12-bit resolution. This is done by adjusting the PGA gain between 1, 2, 4, 8, and 16 until the A/D sample value lies in the upper 50% of the full-scale range (if possible). 256 samples can be taken from the A/D and summed and when the sum is divided by 16 the result is 16 times the average 12-bit sample value. This number, in turn, is divided by the PGA gain, placing the final value appropriately within a 16-bit range.

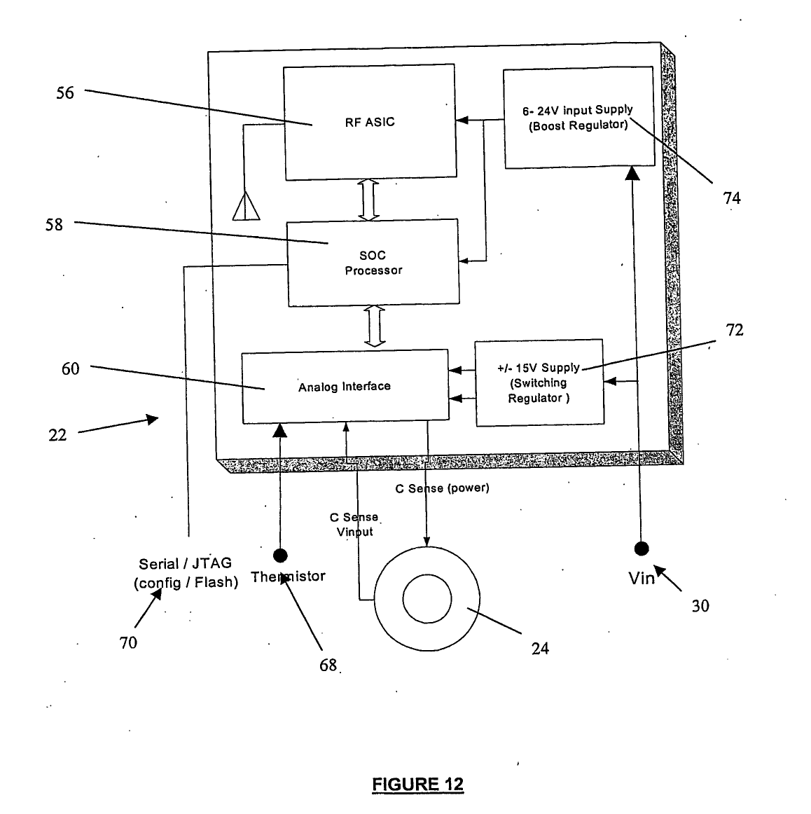

The 6V-24V “buck” type converter 62 receives a power input from the battery 18 and, along with the 2V-6V “boost” type converter, processes the power input so that it can be used to power the voltage telesensor 16. Most of the telesensor circuits operate at 3V. In order to allow a wide range of batteries 18 to be target hosts, a series of voltage regulators are employed. A switching regulator (see reference numeral 72 in FIG. 12) can be used to convert the terminal voltage to an intermediate 5V where the 3V supplies are regulated by Low-Drop Out (LDO) linear regulators. For batteries with terminal voltages greater than 5V, a “buck” type-switching converter 62 shall be applied. These converters typically provide 80%-90% efficiency and allow telesensors 16, 22, 34 to operate on batteries 18 ranging from 6V-24V or 24V-60V. For batteries 18 having a terminal voltage less than 5V, a “boost” type-switching converter 64 and LDO can be used. These converters will provide similar efficiencies to the “buck” type converters 62 but will allow the telesensors 16, 22, 34 to operate on low voltage cells such as 2V Telco cells. Intelligent switching can also be applied to allow a single telesensor 16, 22, 34 to operate over a wide range of batteries 18.

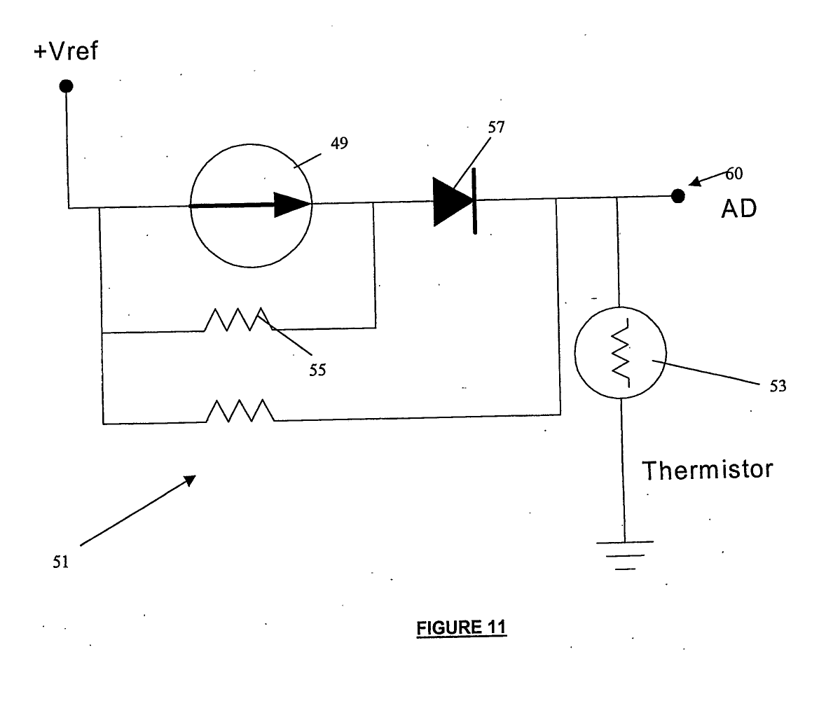

As mentioned above, temperature can be measured remotely from the voltage telesensor 16 by using a thermistor 53 and a constant current source 49. One embodiment of a temperature measuring circuit 51 is shown in FIG. 11. The thermistor 53 can be either attached to a shunt 80 (in a shunt telesensor 34) or to the battery case (in a voltage telesensor 16 or current telesensor 22) to provide a direct indication of battery temperature.

A constant current is derived from reference voltage +Vref using the constant current source 49 and associated components. A passive feedback loop is derived from resistor 55 to keep the current constant under varying loads. A diode 57 provides an active feedback that varies in proportion to temperature to keep the current constant as temperature varies. Resistor 61 provides the gain for diode 57. Variations in temperature cause the resistance of the thermistor 53 to change which causes a voltage drop across the thermistor 53. The voltage drop is proportional to the temperature at the thermistor 53. This voltage is fed into the analog interface circuit 60 which converts it to a digital signal and forwards it to the SOC processor 58. The SOC processor 58 uses a lookup table to convert the digital signal to degrees (C. or F.).

FIG. 12 shows a block diagram of one embodiment of a current sensor 22 according to the present invention. The current sensor 22 comprises an RF/ASIC 56, an SOC processor 58, an analog interface circuit 60, a voltage supply switching regulator 72, and a voltage boost regulator 74. The analog interface circuit 60 receives an input signal from the current transducer 24 as well as a thermistor input 68. Similar to the voltage telesensor 16, the analog interface circuit 60 converts analog input signals into digital signals and forwards the digital signals to the SOC processor 58.

The analog interface circuit 60 also provides a power output 76 to the current transducer 24 for powering the current transducer 24. The voltages generated by the current telesensor 22 for powering the current transducer 24 should normally be set to the +/−12V range but the current telesensor 22 should be capable of generating +/−15V. The current transducer 24 should operate with a nominal +/−12V input voltage requiring less than 100 mA to operate. A control signal can be provided to turn on the current transducer 24. The current telesensor 22 can be defaulted to disable the power to the current transducer 24 and can be activated just prior to a current reading. The current telesensor 22 should be configured to incorporate at least a 15-20 mS delay between power up of the current transducer 24 and the taking of current readings so that the RF/ASIC 56 is not operational until current readings are available for transmission.

The dimensions and current range of the current transducer 24 are dictated by the system to be monitored. Preferably, the current transducer 24 provides four discrete output lines (+V, −V, +Out, and −Out) to the current telesensor 22. The current transducer cable should be un-terminated and attached at the time of installation. A fifth termination shield wire should also be provided.

The current transducer output should be limited to +/−5V and the maximum current range, resolution, and linearity are to be determined by the specific application. The current transducer 24 can be calibrated (zero offset removed) at the time of installation to compensate for local magnetic flux that causes offset.

In one embodiment, the current transducer 24 can be a Hall Effect current measuring transducer. AC/DC current sensing can be achieved by measuring the strength of a magnetic field created by a current-carrying conductor in a semiconductor chip using the Hall Effect principle. When a thin semiconductor is placed at a right angle to a magnetic field and a current is applied to it, a voltage is developed across the semiconductor. This voltage is known as the Hall voltage, named after the scientist Edwin Hall who first observed the phenomenon. When the Hall device drive current is held constant, the magnetic field is directly proportional to the current in the conductor. Thus, the Hall output voltage is representative of that current.

The above described arrangement has two important benefits for universal current measurement. First, since the Hall voltage is only dependent on a magnetic field strength and does not require a reversing magnetic field, as in a current transformer, the Hall device can be used for DC measurement. Second, when the magnetic field strength varies due to varying current flow in the conductor, response to change is instantaneous. Thus, complex AC waveforms can be detected and measured with high accuracy.

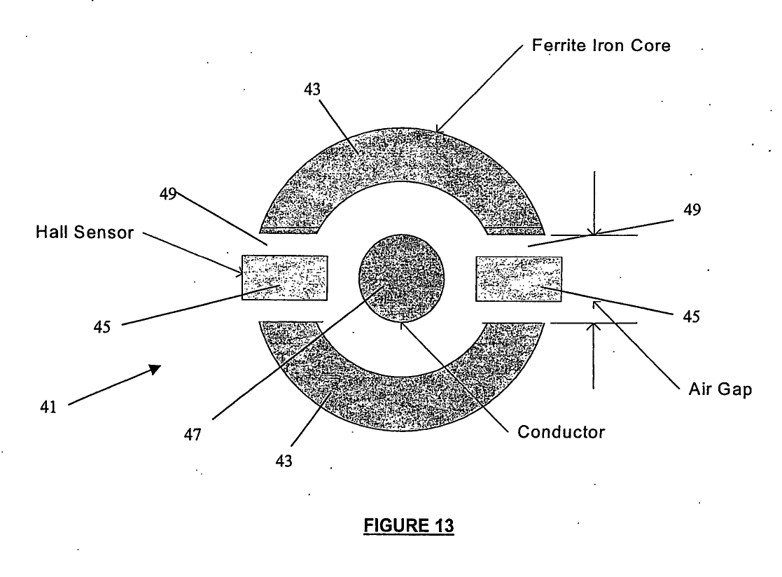

One embodiment of a clamp-on probe current transducer assembly according the present invention is shown in FIG. 13. The clamp-on probe 41 of FIG. 13 comprises a ferrite iron core 43 and two Hall sensors 45 wrapped around a conductor 47 with air gaps 49 between the core 43 and Hall sensors 45. Current flowing through conductor 47 generates a magnetic field around it. This field is captured and contained in the ferrite iron core 43 and passes perpendicularly through the Hall sensors 45 at the air gaps 49.

One problem with this arrangement is that the core 43 concentrates any local magnetic fields into the Hall sensors 45. This appears as an apparent current flowing through the conductor 47. This external flux can be shielded by adding a ferromagnetic shield (not shown) around the assembly, or simply calibrating the assembly by subtracting the offset created by the external flux using an electronic circuit and a potentiometer, or through software.

Another problem with this arrangement is that Hall voltage can be very minute and must be amplified by high gain circuits which are affected by temperature. Compensation current probes have been developed to offset these effects with electronic circuitry also incorporating signal conditioning for linear output and a temperature compensating network. These circuits not only compensate for the temperature but also have a wide dynamic range and frequency response with highly accurate linear output.

Thus, various types of probes 41 can be developed for applications in all areas of current measurement up to thousands of Amperes. Direct currents can be measured without the need of series shunts, and alternating currents up to several kHz can be measured with fidelity to respond to the requirements of complex signals, ripple, and RMS measurements.

The probe outputs are typically in mV (mV DC when measuring DC and mV AC when measuring AC) and are intended to be connected to instruments with a voltage input, such as DMMs, oscilloscopes, etc. The current telesensor 22 can be configured to accept many of these devices as long as the mV/A slope is known and the outputs do not exceed +/−5V. The current telesensor 22 can also provide the power for compensation circuits, typically +/−15V, at several milliamps. Cables, which can be connected to the current telesensor 22, typically include a shield that is connected on a single end to shield the signal lines. The current telesensor 22 can provide for screw terminals and a connector that adapts many different models.

Installation of a probe 41 and current telesensor 22 typically are done in the following manner:
Construct an adaptor cable
Connect the probe 41 to the current telesensor 22
Calibrate the probe 41 (this should be done as close to the battery site as possible so that calibration is done in the magnetic environment in which the device will operate)
Program the range and scale factor
Attach the probe 41 to the conductor 47 (Because the direction of the current effects the polarity, the direction the probe is attached can be important).

Referring back to FIG. 12, the SOC processor 58 provides the control and measurement capabilities of the current telesensor 22. The SOC processor 58 receives the digital signals from the analog interface circuit 60, processes the data encoded in the digital signals and routes data to the RF/ASIC 56 which wirelessly transmits the processed data to the HUB 38 of the control and collection component 14. The SOC processor 58 also includes a serial debug/configuration input 70 which can be used for setting up or maintaining the current telesensor 22.

The switching regulator 72 receives power for the current telesensor 22 from the external power supply 30. The switching regulator 72 converts power generated by the power supply 30 to be usable to power telesensor 22. The boost regulator 74 also receives power from the external power supply 30 and can be configured to boost the power of power supply 30 to be usable to power current telesensor 22. Preferably, the external power supply 30 comprises a DC power source capable of providing 6-24V DC at 300 mA. Alternatively, the external power supply 30 can comprise an AC power supply run through an AC-DC converter.

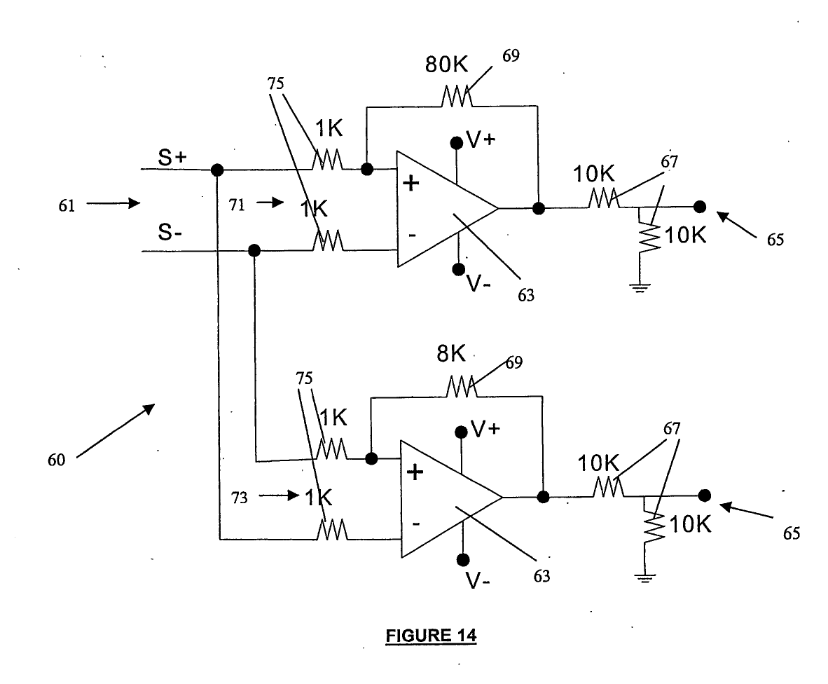

The analog interface circuit 60 of the current telesensor 22 can incorporate scaling amplifiers 63 to convert +/−5V signals from the current transducer 24. One embodiment of an analog interface circuit 60 for the current telesensor 22 is shown in FIG. 14.

Voltage inputs 61 are derived from the current telesensor 22. Voltage −S is closest to the negative reference and S+ is the highest potential. The sign convention is somewhat arbitrary in that (+) is the direction that current flows when the batteries 18 are being charged and (−) is the direction during discharge. The voltage inputs 61 can be converted to two 0V to +2.5V outputs 65 which are provided to the SOC processor 58. The circuit shown in FIG. 14 acts as a precision rectifier because only positive voltage signals may be sent to the SOC processor 58. The charging circuit gain can provide for amplifier feedback to not preclude higher gain configurations.

The amplifiers 63 are configured to provide two gains: AV=80 in the charge direction 71 and AV=8 in the discharge direction 73. This allows roughly a 10:1 current dynamic range to be resolved in both directions. Feedback resistors 69 are used to set the gain of each amplifier 63. The ratio of the feedback resistor 69 to the input resistors 75 of an amplifier 63 determines the amplifier's gain.

The voltage inputs 61 are tied to the opposite polarity inputs of the amplifiers 63 (i.e. S+ is tied to the + input of one amplifier and the − input of the other amplifier) to allow a positive voltage in proportion to the input current which is fed into two separate A/D converter inputs. Protection diodes (not shown) can be added to the outputs to allow only positive voltages to the A/D inputs to be tied to the circuit outputs 65.

If the analog interface circuit 60 is used in a current telesensor 22, the voltages typically will exceed the full scale inputs and must be scaled in half. This scaling is provided by resistive dividers comprising 10KΩ resistors 67 at the outputs 65. If the analog interface circuit 60 is being used in a shunt telesensor 34, the resistance is small making the voltages minute. Thus, the voltages must be amplified to provide the +2.5V (Full scale) output 65.

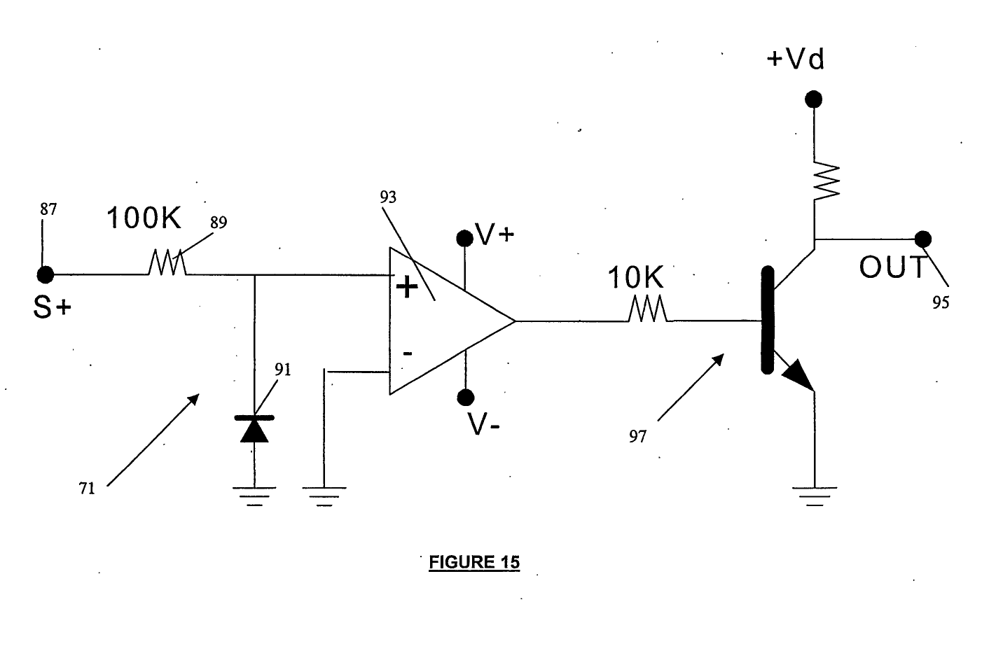

A sign bit can also be set in the analog interface circuit 60 to indicate a charge/discharge condition. One embodiment of a sign indication circuit 85 is shown in FIG. 15. The sign bit can be used to generate an interrupt or simply be polled to indicate which SOC processor 58 input 65 needs to be read.

The S+ voltage from the telesensor provides the input 87 to the sign indication circuit 85. A large input resistor 89 isolates the circuit 85 from other components of the system. The input resistor 89 and a protection diode 91 ensure that only positive voltages are applied to amplifier 93. The amplifier 93 is operated with a large gain that acts like a switch so that V+ present at the output 95 when a positive voltage is present at input 87. When the input is zero or negative, the output 95 is zero. The output 95 is converted to the system logic levels (1 or 0) by a saturating transistor switch 97, which operates at the digital voltage level (+Vd) maximum.

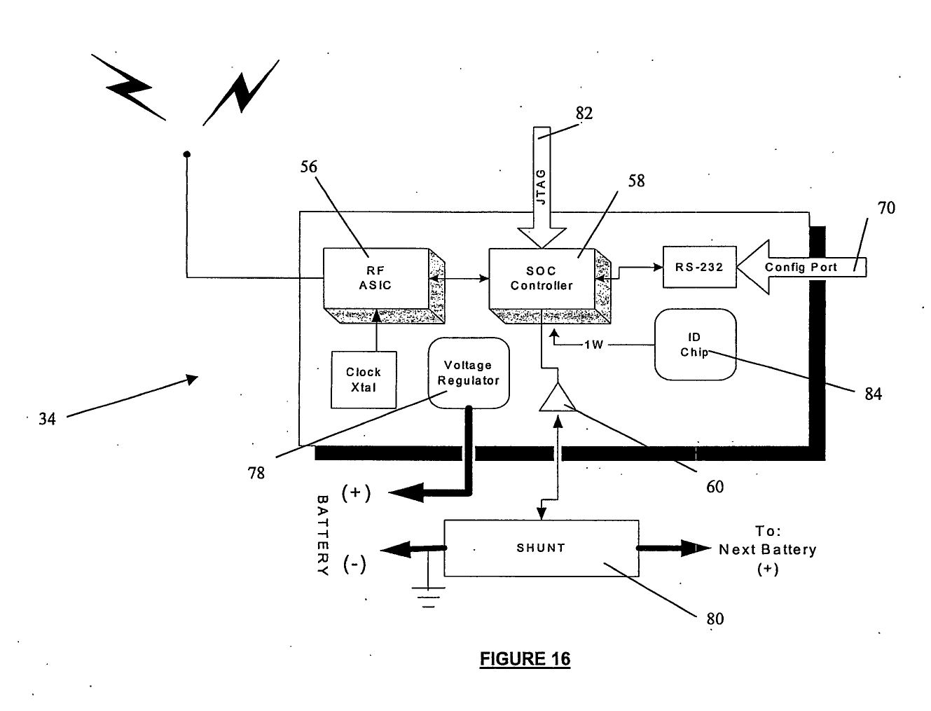

FIG. 16 illustrates one embodiment of a shunt telesensor 34 according to the present invention. The shunt telesensor 34 comprises an RF/ASIC 56, an SOC processor 58, an analog interface circuit 60, and a voltage regulator 78. The voltage regulator 78 receives an input voltage from the battery 18 and uses the input voltage to power the shunt telesensor 34.

The analog interface circuit 60 receives an input from a shunt 80 which is attached to the inter-battery tie 36. Preferably, the shunt 80 comprises a metal alloy ribbon having a low temperature coefficient that allows accurate current readings by measuring a small predictable voltage drop across the shunt 80. The shunts 80 are rated for the maximum current it expects to measure. The shunts 80 are typically rated in millivolts (mV) per full-scale amperes (A) (e.g. 100 mV/100 A). The shunt 80 should be rated in such a manner that the temperature of the alloy ribbon remains below 145° C. at which point the alloy's properties risk permanent damage. The shunt 80 may also include heat sinks (not shown) to extend its range.

Two gains can be used to read the shunt 80. Since charging current is expected to be on the order of tens of Amps, with float current in the range of less than 1 A, a greater gain can be used for measuring these currents. An arbitrary sign of (+) can be used to indicate a charging current. Since the resistance of the shunt 80 is very small (typically 5-10 mΩ) the voltage developed across the shunt 80 is fairly small. With a 12-bit A/D, and a 2.5V reference, an amplifier with a gain of 80 can be used. Conversely, discharge current (−) is expected to be in the 100's of Amps and since the same A/D circuits are employed, a gain of 8 can be used. Thus, the same device can be used to measure small charging currents as well as large discharge currents.

The analog interface circuit 60 provides a digital signal to the SOC processor 58. The SOC processor 58 provides the control and measurement capabilities of the shunt telesensor 34. The SOC processor 58 receives the digital signals from the analog interface circuit 60, processes the data encoded in the digital signals and routes data to the RF/ASIC 56 which wirelessly transmits the processed data to the HUB 38 of the control and collection component 14. The SOC processor 58 also includes a serial debug/configuration input 70 which can be used for setting up or maintaining the shunt telesensor 34. The SOC processor 58 also includes a JTAG input 82 for factory programming, testing, field parameter storage and firmware upgrades, and an input from an ID chip 84 which provides a unique identifier for the individual telesensor units. Preferably, the ID chip 84 acts an electronic serial number and can be 64 bits in length.

Referring back to FIGS. 6a and 6b, the master unit telesensor 42 also includes an RF/ASIC, an SOC processor, and a voltage regulator. In addition, the master unit telesensor 42 includes a serial, RS232 communication port for connecting to a user workstation 52 or to a gateway 44 to make the battery data available to an end user as described in more detail above with respect to the control and collection component 14. The SOC processor of a master unit telesensor 42 can be configured to convert data into an RS232 level signal so that the master unit telesensor 42 can interface with a user workstation 52 or gateway 44. Preferably, any telesensor 16, 22, 34 can be configured to operate as a master unit telesensor 42. The serial, RS232 communication port can cause a signal or interrupt to the SOC processor indicating that the telesensor is operating as a master unit telesensor 42. The RS232 port can also be used for configuration or debugging purposes.

The telesensors 16, 22, 34, 42 are configured to operate in various modes. For example, in the master mode, the telesensor operates as a master unit 42, while in the slave mode, the telesensor 16, 22, 34 is configured to take various battery system measurements.

In the slave mode, the RF/ASCI 56 remains in a low-power sleep state between transmission and sampling events. The sleep state reduces the power consumption of the device by about 50%. The slave uses a simple event scheduler to awaken at the time of the next event, which is either sampling or transmission. Sampling can be scheduled at 10-second intervals during the first two minutes of operation after power is applied. This initial fast sampling interval is performed to facilitate testing during installation. Subsequently, sampling can be set to occur at intervals of 1-15 minutes, which are more typical sampling period rates.

All telesensor data sample can be stored in a portion of the SOC processor's main flash memory. This area can be comprised of two 512-byte flash sectors, although the size of these sectors can be varied. The flash memory area can be utilized as a circular buffer. When a particular sector is filled completely, the next sector is immediately erased. If an overflow of this circular buffer occurs, the oldest sector of sample data can be lost. If a sample cannot be transmitted immediately to a master unit 42, the sample log buffer provides a recovery mechanism. The samples can be transmitted at a later time, even after a power failure, since they are stored sequentially in non-volatile memory.

Data gathered by the SQC processor 58 is stored. The SOC processor 58 also controls operation of the RF/ASIC 56. Data is transferred in a Time Division Duplex (TDD) format. Once in sync, the slave telesensor 16, 22, 34 begins to transmit; the master unit 42 locks onto the slave, and the master unit 42 and slave telesensor 16, 22, 34 alternatively transmit.

In actual operation, the system 10 periodically (several minutes typically) wakes up the SOC processor 58 and tunes the receiver portion of the RF/ASIC 56 to various channels in search of a master unit 42. The system 10 is designed to allow only one master unit/telesensor pair to be transmitting at any given time. A controlling master unit 42 is periodically beaconing on each channel in the ISM band. The master unit 42 is configured to be ready to accept a new telesensor 16, 22, 34 on a channel or to be currently communicating with one. The status of the master unit 42 is communicated in the 8-bit control channel. After is transmitted from a telesensor 16, 22, 34, the telesensor 16, 22, 34 switches off its transmitter and goes back into sleep mode. The master unit 42 also stops transmitting on the channel and moves to another channel thus preventing any one channel from being used on a continuous basis. If the new channel is clear, the master unit 42 begins beaconing for the next telesensor 16, 22, 34. If no telesensors are found within a certain time interval, the master unit 42 will again change its beaconing frequency.

The RF/ASIC 56 is capable of transporting a small quantity of telesensor data (about 30 bytes) from a slave 16, 22, 34 to a master unit 42 every 1 to 15 minutes. A HUB 38 can be configured to support a sizable number of slave telesensors 16, 22, 34. State machine on both the master and slave ends implement the protocol.

The master mode is the receiving portion of the protocol used by the master unit 42 at the HUB 38 to collect slave radio messages from the telesensors 16, 22, 34 for subsequent delivery to the user workstation 52. During idle times, the master unit 42 continuously transmits its idle channel beacon code on the data channel, and its master ID via the fast data channel. The master unit 42 waits for a telesensor 16, 22, 34 to acquire sync.

The master unit RF/ASIC changes its channel center frequency at an interval of about 15 ms during its search for a slave telesensor 16, 22, 34. The channel sequence is specified by the active channel settings in the flash configuration of the master unit 42. The master unit RF/ASIC traverses the active channel table in a forward direction or from lowest to highest channel number. Once communication is established with a slave telesensor 16, 22, 34, no further channel changes occur until the master unit 42 is once again idle and searching for another slave telesensor 16, 22, 34.

When the master unit 42 receives a pre-connect code from a slave telesensor 16, 22, 34, it verifies that the fast data channel simultaneously contains a valid slave ID and CRC. If this is true, the master unit 42 acknowledges the slave telesensor 16, 22, 34 with the same pre-connect code and its master ID in the fast data channel.

After transmitting the pre-donnect code, the master unit 42 awaits the slave telesensor 16, 22, 34 response of a connect code. If received, the master unit 42 replies in turn with the same connect code and subsequently expects to receive data from the slave telesensor 16, 22, 34. This data is received in the form of a series of payloads along with the data channel containing the data code. The master unit 42 and slave telesensor 16, 22, 34 both understand one single message format. The first byte of a sample message contains a CRC covering the remaining bytes of the message. Upon receipt, the master verifies the data integrity by calculating the CRC code itself, then comparing the code to the transmitted CRC value. If it matches, the transmission is deemed successful and the slave telesensor 16, 22, 34 is acknowledged with a successful transmission code. If the CRC did not match, the master unit 42 sends a different code and awaits retry transmission from the slave telesensor 16, 22, 34.

The slave mode applies to all battery telesensors 16, 22, 34 that collect data for transmission to a master unit 42. A slave telesensor 16, 22, 34 traverses the active channel table in a reverse direction or from highest to lowest channel number. Once communication is established with a master unit 42, no further channel changes occur during the transaction with the master unit 42.

When the slave locates a master beacon code from a master unit 42 on the current channel, it verifies that the fast data channel simultaneously contains a valid master ID and CRC. If this is true, the slave telesensor 16, 22, 34 acknowledges the master unit 42 by enabling its transmitter and sending the pre-connect code and its slave ID in the fast data channel. The slave telesensor 16, 22, 34 will search for a master beacon only for a maximum of 750 ms before returning to the sleep state. The slave telesensor 16, 22, 34 will attempt to locate a master unit 42 again; after the sleep period is complete.

After sending the pre-connect code to the master unit 42, the slave telesensor 16, 22, 34 awaits a response from the master unit 42 containing the connect code and the master ID. Upon receipt of this message, the slave telesensor 16, 22, 34 replies with a connection acknowledge code. The master unit 42 should then reply again with the connection acknowledge code, at which point the slave telesensor 16, 22, 34 can begin data transmission to the master unit 42. If at any point during handshaking an error occurs, the slave telesensor 16, 22, 34 is disabled and the slave state machine returns to the initial state (search for master beacon).

The slave telesensor 16, 22, 34 transmits a data sample to the master unit 42 as a series of data packets in the radio fast data channel, while the command data channel contains the data code. The sample data contains as its first byte a CRC cod check over the remaining data of the sample message. The slave telesensor 16, 22, 34 and the master unit 42 both expect the sample data to be of the same length and format. This information is not negotiated or transmitted as both ends are configured to understand only one data packet format.

After the slave telesensor 16, 22, 34 transmits the last payload of sample data, the master unit 42 verifies the data by comparing the CRC byte of the sample to its calculation of the CRC value over the remaining sample data. If the calculated CRC matches the transmitted CRC, the master unit 42 responds to. the slave telesensor 16, 22, 34 with the successful transmission code. The slave's receipt of this code terminates the transmission sequence. If any other. code is received, the slave telesensor 16, 22, 34 resends the entire message payload sequence. This will be retired up to a maximum number of time (which is usually set to 10) at which point the slave telesensor 16, 22, 34 will terminate communication unilaterally. The sample data is not discarded however, and another attempt will be made to transmit the data after the next radio sleep period.

Software run in the control and collection component 14 of the system 10 can perform a variety of functions, for example:

Report battery condition—displays the current, voltage, and temperature detected from a telesensor

Calibrate, sensor offset—performs current telesensor zero calibration. Zero current should be applied to during this test. This calibration should be performed prior to the charge gain or discharge gain calibration functions (the Configuration, write to flash command should be used to store this result to the flash configuration in order for the change to survive after the next power-on).

Calibrate, charge gain—performs current telesensor calibration in the charging direction. A current of +5 A can be applied during this test. The offset calibration (from the Calibrate, sensor offset command) should have been performed at least once before gain calibrations are performed (the Config, write to flash command should be used to store this result to the flash configuration in order for the change to survive after the next power-on).

Calibrate, discharge gain—performs current sensor calibration in the discharging direction. A current of −5 A can be applied during this test (the Configuration, write to flash command should be used to store this result as well).

Configuration, get defaults—sets the working configuration parameters equal to the default parameters defined in the ROM (not by the flash configuration) of the telesensor (the Configuration, write to flash command should be used to store this result as well).

Configuration, erase memory—erases the flash memory configuration data completely. The default parameters will be installed on the next power-up

Configuration, read from flash—re-reads the flash configuration data into the working configuration stored in RAM.

Configuration, show—displays the working configuration parameters in RAM.

Configuration, write to flash—stores the working configuration parameters in RAM to the flash memory. The flash memory settings survive the next power-on, and are used as the preferred operating parameters for the radio. At power-on, these parameters are copied into a working configuration set in RAM.

Disable transmit channel—modifies the hopping table to disable the channel number specified as a parameter. The channel will not be utilized in the hopping sequence (the Configuration, write to flash command should be used to store this value).

Enable transmit channel—modifies the hopping table to enable the channel number specified as a parameter. The channel will then be utilized in the hopping sequence (the Configuration, write to flash command should be used to store this value).

Set channel transmit power—modifies the hopping table by altering the transmit power setting on a single channel number specified as the parameter. When the radio hops through the sequence, this channel will transmit at the specified power level (0, 2, 3 . . . ). The level numbers correspond to +2, +8, +14, and +20 dBm respectively (the Configuration, write to flash command should be used to store this value).

Show all channels—displays the channel hopping table currently in RAM. This is not necessarily the same as the flash configuration if changes have been made with disable or enable transmit channel, or the set channel transmit power commands without storing the results using a configuration, write to flash command.

ROM CRC check—calculates the 32-bit ROM CRC code over the program memory of the flash.

Select output format—selects either XML or Debug output formats for data transmitted via the RS-232 port.

Erase log—erases the flash memory sample log buffer.

Show log—displays the flash memory sample log buffer.

Select master/slave mode—changes the radio's mode of operation. The normal mode of operation is “cable selected”, meaning that the radio will operate in the slave mode if it is not attached to a host via an RS-232 cable; if connected, it will operate as a master (the Configuration, write to flash command should be used to store this value).

Radio, show/set channel—displays or permits changing the current radio channel used during various tests.

Radio, 50% CS mode—activates continuous-spreading mode, with 50% transmit duty.

Radio, CW mode—activates continuous-wave transmit mode with 100% duty.

Radio, shut off—places the radio in the power-down state.

Select PN sequence—selects one of seven PN-code sequences to be applied to the hopping channel series. Radios must have the same PN sequence setting to communicate. Variation of this parameter permits up to seven independent pools of radios to coexist without engaging in communications between the pools (the Configuration, write to flash command should be used to store this value).

Radio, show/set power—adjusts the transmit power of the radio in CS or CW mode.

Radio, rssi—displays radio received signal strength in dBm. This result is most meaningful if a slave is locked to a master on the same channel.

Telesensor calibration can be one in a three-set process. The first step can be a zero offset calibration, followed by two gain calibrations (one for each polarity of sensed current). During the first step, a zero volt potential (and therefore zero current) is applied to the shunt and a “calibrate, sensor offset” command is executed. The software can perform multiple sample averages to find the offset, which is typically around 1800 h.

In the second step, a current of +5 A is applied to the shunt and a “calibrate, charge gain” command is executed. Again, the software can perform multiple sample averages to find the calculated gain factor, which is typically about 80-100. In the third step, a current of −5 A is applied through the shunt and a calibrate, “discharge gain” command is executed. Multiple sample averages are taken to determine the resulting calculated gain factor, which is typically about 8-10.

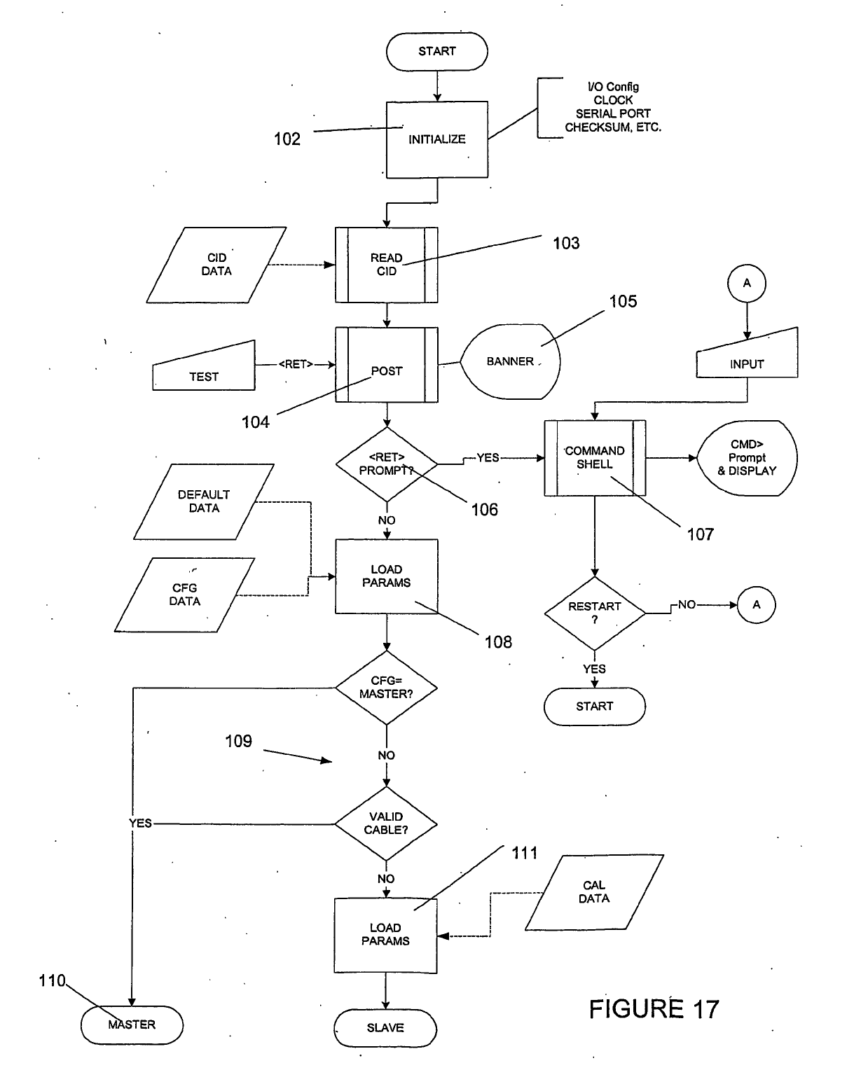

FIG. 17 illustrates one embodiment of the firmware initialization process. After telesensor startup or reset, the firmware initiates telesensor initialization 102. During initialization, various configuration and default parameters, such as the I/O configurations, serial ports and the Real time clock (RTC) are cleared and the ROM checksum data is found. Next, in step 104, the chip ID is read from the ID chip to be used as the telesensor's electronic serial number ID. In step 104, the power-on-self-test (POST) is run which performs several self tests such as RAM checks, and the results of the POST are displayed in a serial banner in step 105. The firmware checks to see if a serial port is connected and a <Return> character ID is received in step 106. If so, a command shell is executed in step 107. If not, all of the default data and configuration parameters are loaded from ROM in step 108. Next, in step 109, the firmware tests to determine if a valid master cable is found. If so, the telesensor assumes the role of a master unit in step 110. If not, all of the calibration parameters are loaded for the slave configuration in step 111.

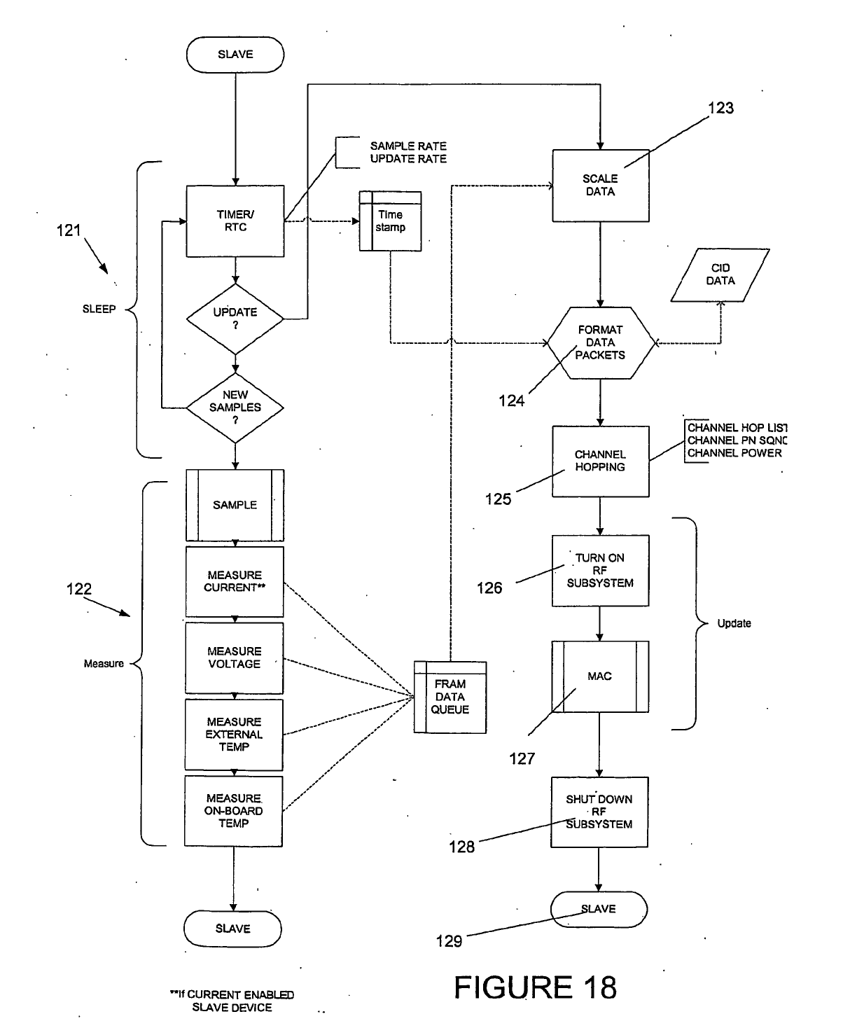

FIG. 18 shows the slave or telesensor mode of operation. The telesensor operation includes a sleep mode 121 during which two sleep timers are run, one for the update rate and a second for the sample rate. When the sample rate timer expires, the telesensor enters a sample mode 122. During the sample mode 102, samples are taken such as voltage, temperature, and current reading samples. This data is stored in flash RAM (FRAM) for later formatting and transmission. When the update rate timer expires, data from the FRAM is scaled in step 123. Packets are formed in step 124 when the scaled data, the timestamp, and chip ID are concatenated in preparation for transmission. Transmission starts, step 125, by selecting a channel from a hop list; a PN sequence and the output power are also set during this step. The RF subsystem is switched on, step 126, because it is normally in an off state for power savings. The media access control (MAC) process is started, step 127, which transfer the packet(s) to the HUB. After successful transmission (or timeout), the radio section is once again put into a low-power state, step 128, and the process restarts, step 129.

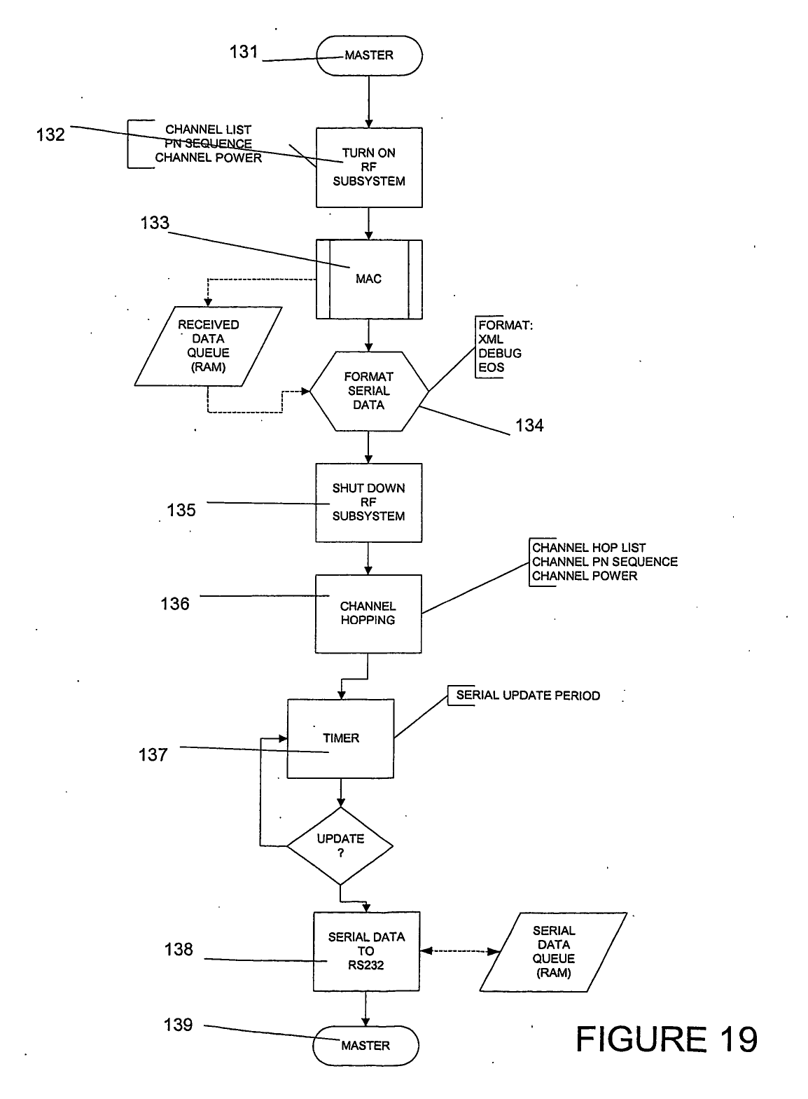

FIG. 19 shows the HUB (Master) mode of operation. The process is entered, step 131, after the serial port has been detected. Various parameters, such as a frequency list, PN sequence, and the channel power are loaded into the RF system in step 132. The MAC process starts, step 133 and any telesensor data received is formatted, step 134, for tranmission on the serial channel. The RF subsystem is then shut down, step 135, and the channel is abandoned, step 136, to avoid jamming of other services. The pace of the data forwarded is controlled by a timer or flow control in step 137. Finally, the serial data is transmitted to the host or gateway, step 138, and the process is restarted, step 139.

While the particular systems and methods for sensing herein shown and described in detail are fully capable of attaining the above described objects of the this invention, it is to be understood that the description and drawings presented herein represent one embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A remote battery monitoring system for monitoring the health and/or status of a plurality of batteries arranged in a battery string, the system comprising:
a plurality of telesensors, each telesensor connected to a battery in the battery string;
a control and collection unit wirelessly coupled to the plurality of telesensors;
wherein each telesenor is configured measure battery data representing the health and/or status of the battery to which it is connected and to wirelessly transmit the battery data to the control and collection unit; and
wherein the control and collection unit is configured to receive and process the battery data from the plurality telesensors.

2. The system of claim 1 wherein each telesensor comprises a voltage telesensor configured to measure battery voltage.

3. The system of claim 2 further comprising a current telesensor attached to the battery string the current telesensor configured to measure current in the battery string.

4. The system of claim 1 wherein each telesensor comprises a shunt telesensor configured to measure battery voltage and current.

5. The system of claim 1 wherein each telesensor is configured to measure battery temperature.

6. The system of claim 1 wherein the control and collection unit comprises:
a HUB configured for wirelessly communicating with the plurality of telesensors to receive battery data from the plurality of telesensors; and
a monitoring unit configured for receiving the battery data from the HUB and for processing and storing the battery data.

7. The system of claim 6 wherein the HUB is located at the battery string site and the monitoring unit is located remotely from the battery string site.

8. The system of claim 6 wherein the HUB comprises:
a gateway; and
a master unit telesensor connected to the gateway;
wherein the master unit telesensor is configured to wirelessly communicate with the plurality of telesensors and the gateway is configured to provide a communication link to the monitoring unit.

9. The system of claim 8 wherein the gateway is configured to connect the monitoring unit to the master unit telesensor through a wide area network.

10. The system of claim 6 wherein the monitoring unit comprises:
an applications server configured to store battery data; and
a user workstation configured to access and display the battery data.

11. The system of claim 6 wherein the HUB and monitoring unit are located remotely from the plurality of telesensors.

12. The system of claim 11 wherein the monitoring unit comprises a user workstation and the HUB comprises a master unit telesensor connected to the user workstation.

13. The system of claim 6 further comprising remote monitoring software running on the monitoring unit, the remote monitoring software configured to process and analyze battery data.

14. The system of claim 13 wherein the remote monitoring software is further configured for triggering warning alarms when the battery data falls outside of preprogrammed operating limits.

15. The system of claim 1 wherein the control and collection unit is further configured to provide control signals to the plurality of telesensors requesting that battery data measurements be made.

16. The system of claim 1 wherein each telesensor is further configured to wirelessly transmit information regarding the status of the telesensor to the control and collection unit.

17. The system of claim 1 wherein each telesensor comprises:
a radio for wirelessly transmitting battery data; and
a processor for providing the telesensor with control and measurements capabilities.

18. The system of claim 1 wherein each telesensor is configured to receive power parasitically from the battery to which it is attached.

19. A telesensor for measuring the health and/or status of a battery, the telesensor comprising:
an analog interface circuit for receiving analog inputs from a battery and converting the analog inputs into digital signals;
a processor connected to the analog interface circuit for receiving the digital signals from the analog interface circuit and for processing data encoded in the digital signals into battery data;
a radio connected to the processor for receiving the battery data from the processor and for wirelessly transmitting the battery data to a remote unit.

20. The telesensor of claim 19 wherein the battery data comprises the battery voltage.

21. The telesensor of claim 19 wherein the battery data comprises discharge current.

22. The telesensor of claim 19 wherein the battery data comprises charge current.

23. The telesensor of claim 19 wherein the battery data comprises battery temperature.

24. The telesensor of claim 19 wherein the telesensor is configured to receive power parasitically from the battery.

25. The telesensor of claim 19 further comprising a Hall Effect current measuring transducer.

26. The telesensor of claim 19 wherein the processor further comprises a debug/configuration input for use in setting up and maintaining the telesensor.

27. The telesensor of claim 19 wherein the analog interface circuit further comprises scaling amplifiers configured to provide different gains during battery charge and battery discharge conditions.

28. The telesensor of claim 19 further comprising a sign indication circuit configured to indicate either a battery charge or battery discharge condition.

29. The telesensor of claim 19 further comprising an ID chip for providing a unique electronic identification symbol.

30. The telesensor of claim 19 further comprising operational firmware for initializing and controlling operation of the telesensor.

31. A method for initializing and controlling operation of a telesensor configured to measure the health and/or status of a battery, the method comprising the steps of:
loading default initialization parameters into the telesensor;
determining a unique ID for the telesensor;
conducting a telesensor self test;
determining whether the telesensor has received a serial port configuration signal;
determining whether the telesensor is a master or slave telesensor;
loading telesensor specific configuration parameters into the telesensor.

32. The method of claim 31 wherein the telesensor is a slave telesensor, the method further comprising:
waking the telesensor up from sleep mode;
measuring battery data;
temporarily storing the battery data;
scaling the stored battery data;
forming packets including the scaled data;
wirelessly transmitting the packets to a remote unit.

33. The method of claim 32 wherein the step of wirelessly transmitting further comprises:
selecting a transmission channel from a hop list;
switching on a radio subsystem of the telesensor;
starting a media access control process which transmits the packets to the remote unit via the selected transmission channel;
switching the radio subsystem into a low-power sleep state.

34. The method of claim 31 wherein the telesensor is a master telesensor, the method further comprising:
loading master telesensor configuration parameters into the master telesensor;
switching on a radio subsystem of the telesensor;
starting a media access control process which receives packets from a remote slave telesensor;
extracting and formatting data from the received packets;
switching the radio subsystem into a low-power sleep mode;
transmitting the formatted data to a monitoring unit.
